(19) United States
(12) Patent Application Publication
(10) Pub. No.: US 2013/0173978 A1
(43) Pub. Date: Jul. 4, 2013

(54) MULTIPLE INPUT AND/OR OUTPUT DATA FOR BOUNDARY SCAN NODES

(71) Applicants: Hiroyuki Sasaya, Tokyo (JP); Supatra Basu, Mumbai (IN)

(72) Inventors: Hiroyuki Sasaya, Tokyo (JP); Supatra Basu, Mumbai (IN)

(21) Appl. No.: 13/342,035

(22) Filed: Jan. 1, 2012

(51) Int. Cl. G06F 11/267

(52) U.S. Cl. 714/727; 714/E11.162

(57) ABSTRACT

A boundary scan node of a boundary scan chain for testing an associated node of core logic core logic includes a first boundary scan cell having an input that is coupled to a first data output of the core logic. A second boundary scan cell having an output is coupled to a first data input of the core logic. A programmable series connection is arranged to selectively couple an output of the first boundary scan cell to an input of the second boundary scan cell when the boundary scan node is arranged in an internal test mode for the core logic. Test stimulus can be written to the boundary scan node using a data register clock and test results can be read from the boundary scan node using the data register clock.

### BACKGROUND

Scan flip-flops are commonly used in a wide variety of circuits including application specific integrated circuits (ASIC), digital signal processors (DSP), and microprocessors, for example. In very large scale integration (VLSI) circuits, (e.g., on the scale of billions of transistors) typical designs include a significant portion of scan flip-flops (e.g., scan registers, scan master/slave latches) for test and verification. A serial chain of scan flip-flops is provided around one or more interior portions of logic (core logic) for providing test stimulus (input) data for testing and capturing test result (output) data.

Data for testing a core portion is clocked into the scan chain at a clock rate that is suitable for driving input/output (I/O) pads. However, the scan chain clock rate is often slower than a clock rate than an internal (core logic) clock rate that is used when testing the core logic. Accordingly, conventional approaches limit the rate of application of data to core logic when the core logic is under test. Further, size and power limitations and I/O pin counts of cost-effective silicon solutions limits the complexity of circuitry provided for testing.

### SUMMARY

The problems noted above are solved in large by providing a selectable series connection between an output shift/capture register and an input shift/capture register in scan flip-flops of a scan chain. An IEEE (Institute of Electrical and Electronics Engineers) boundary scan standard (such as the IEEE 1149 implementation of the Joint Test Action Group—JTAG—boundary scan scheme) can be modified using relatively few components in accordance with the teachings disclosed herein. The series connection allows multiple data to be asserted while the core logic being tested is, for example, executed at a core logic clock rate that is higher than the scan chain clock rate. Asserting multiple data while the core logic being tested is executed at a core logic clock rate allows for more robust at-speed (e.g., at a normal operating core clock rate) testing of the core logic.

As disclosed herein, a boundary scan node of a boundary scan chain for testing an associated node of core logic core logic includes a first boundary scan cell having an input that is coupled to a first data output of the core logic. A second boundary scan cell having an output is coupled to a first data input of the core logic. A programmable series connection is arranged to selectively couple an output of the first boundary scan cell to an input of the second boundary scan cell when the boundary scan node is arranged in an internal test mode for the core logic. Test stimulus can be written to the boundary scan node using a data register clock and test results can be read from the boundary scan node using the data register clock.

### BRIEF DESCRIPTION OF THE DRAWINGS

FIG. 1 shows an illustrative computing device 100 in accordance with embodiments of the disclosure.

FIG. 2 is a schematic diagram illustrating a conventional boundary scan test node.

FIG. 3 is a schematic diagram illustrating a multiple input data boundary scan test node in accordance with embodiments of the disclosure.

FIG. 4 is a timing diagram illustrating operation of a multiple input data boundary scan test node in accordance with embodiments of the disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms throughout the following description and claims are used to refer to particular system components. As one skilled in the art will appreciate, various names can be used to refer to a component. Accordingly, distinctions are not necessarily made herein between components that differ in name but not function. In the following discussion and in the claims, the terms “including” and “comprising” are used in an open-ended fashion, and thus are to be interpreted to mean “including, but not limited to . . . .” Also, the terms “coupled to” or “couples with” (and the like) are intended to describe either an indirect or direct electrical connection. Thus, if a first device couples to a second device, that connection can be through a direct electrical connection, or through an indirect electrical connection via other devices and connections. Further, the term “high” is generally intended to describe a signal that is at logic state “1,” and the term “low” is generally intended to describe a signal that is at logic state “0.” The term “on” applied to a transistor or group of transistors is generally intended to describe gate biasing to enable current flow through the transistor or transistors. The term “off” applied to a transistor or group of transistors is generally intended to describe gate biasing to disable current flow through the transistor or transistors.

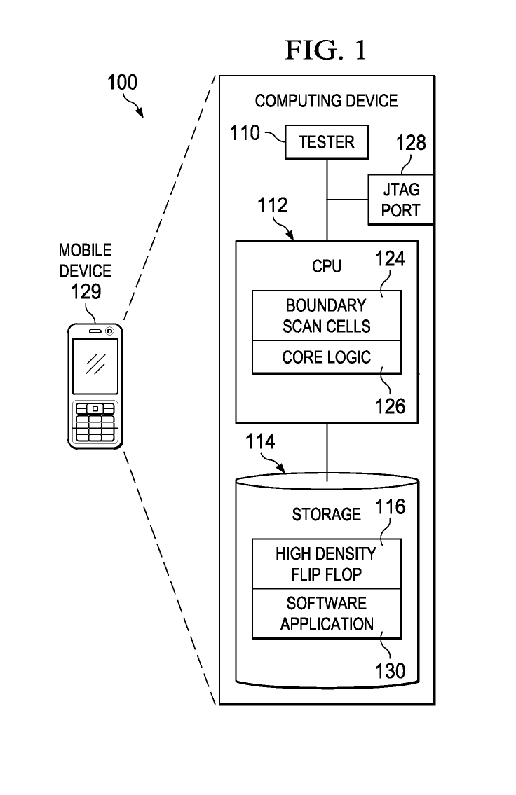

FIG. 1 shows an illustrative computing device 100 in accordance with embodiments of the disclosure. The computing device 100 is, or is incorporated into, a mobile communication device 129, such as a mobile phone, a personal digital assistant (e.g., a BLACKBERRY® device), a personal computer, or any other type of electronic system.

In some embodiments, the computing device 100 comprises a megacell or a system-on-chip (SoC) which includes control logic such as a CPU 112 (Central Processing Unit), a storage 114 (e.g., random access memory (RAM)) and tester 110. The CPU 112 can be, for example, a CISC-type (Complex Instruction Set Computer) CPU, RISC-type CPU (Reduced Instruction Set Computer), or a digital signal processor (DSP). The storage 114 (which can be memory such as RAM, flash memory, or disk storage) stores one or more software applications 130 (e.g., embedded applications) that, when executed by the CPU 112, perform any suitable function associated with the computing device 100. The tester 110 comprises logic that supports testing and debugging of the computing device 100 executing the software application 130. For example, the tester 110 can be used to emulate a defective or unavailable component(s) of the computing device 100 to allow verification of how the component(s), were it actually present on the computing device 100, would perform in various situations (e.g., how the component(s) would interact with the software application 130). In this way, the software application 130 can be debugged in an environment which resembles post-production operation.

The CPU 112 typically comprises memory and logic which store information frequently accessed from the storage 114. Various subsystems (such as the CPU 112 and the storage 114) of the computing device 100 include boundary scan cells (e.g., boundary scan cells 124) and core logic (e.g., core logic 126) to be tested by a scan chain that is associated with the core logic. For example, boundary scan cells 124 are used to provide test stimulus (input data) and capture test results (output data) to and from core logic 126. Disclosed herein are techniques for enabling an in-circuit test capability of boundary scan architecture to provide differing test stimulus and capture test results at differing times of a single test at each boundary scan node using an at-speed clock.

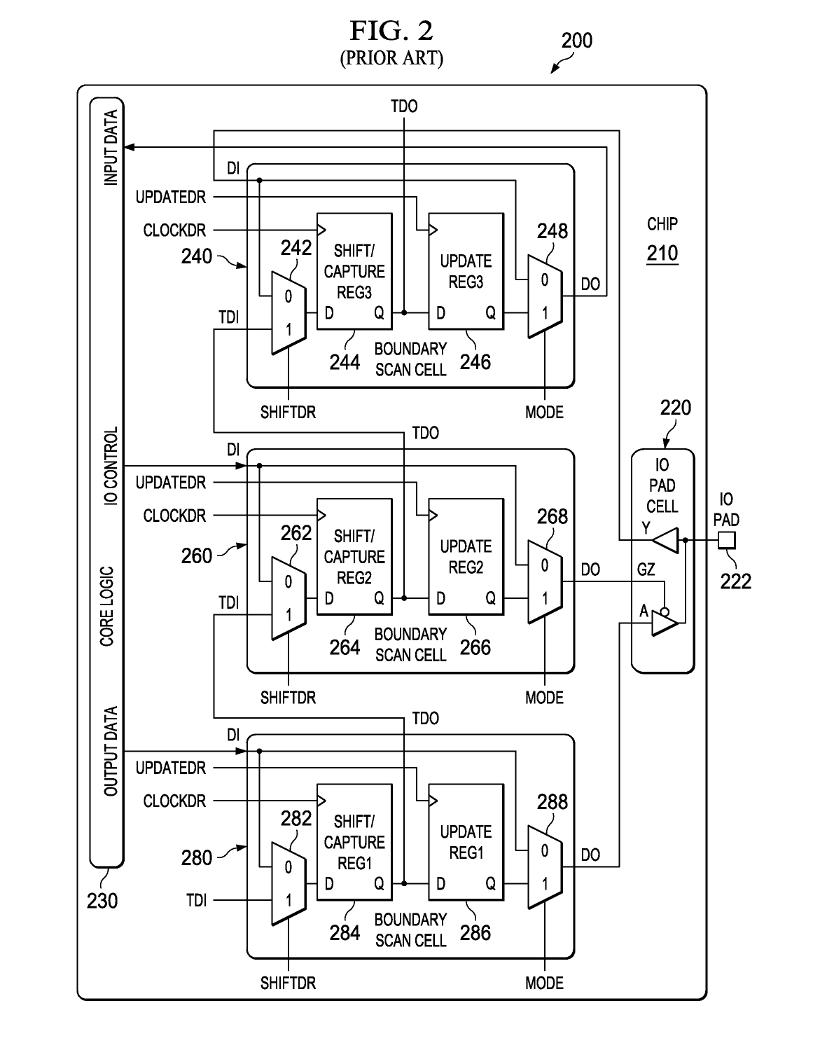

FIG. 2 is a schematic diagram illustrating a conventional boundary scan test node. Boundary scan test node 200 includes chip (substrate) 210, I/O pad cell 220, core logic 230, and boundary scan cells 240, 260, and 280. Boundary scan test node 200 is formed on chip 210, which typically includes other boundary scan test nodes.

I/O pad cell 220 is provided to input data to or output data from core logic 230 as well as to provide test stimulus (signal Y) and receive test results (signal A) of the boundary scan test node 200 in an external test (EXTEST) mode. Signal GZ (output enable) controls whether signal A is to be driven as an output or whether an input signal present at the I/O pad 222 is read as an input.

Core logic 230 provides an input data signal, a control output signal, and an output data signal for testing using the boundary scan cells 240, 260, and 280. Boundary scan cell 240 is arranged to select and latch the data input signal of core logic 230. Boundary scan cell 260 is arranged to select and latch the I/O control output signal of core logic 230. Boundary scan cell 280 is arranged to select and latch the data output signal of core logic 230.

Boundary scan cell 280 includes an input multiplexor 282, a shift/capture register 284, an update register 286, and an output multiplexor 288. Signals TDI (“test data in” of the scan chain) and signal DI (“data in” that is coupled to the output data signal of core logic 230) are coupled to data inputs of input multiplexor 282. Input multiplexor 282 is arranged to select between signals TDI and DI in response to signal ShiftDR (shift data register). The output of input multiplexor 282 is coupled to the input of shift/capture register 284, where signal ClockDR (clock data register) is arranged to latch (as an output) the output of input multiplexor 282. The output of shift/capture register 284 is coupled to the input of update register 286, where signal UpdateDR (update data register) is arranged to latch (as an output) the output of update register 286. Output multiplexor 288 is arranged to output as DO (data output) TDI and DI in response to signal UpdateDR (shift data register). Signal TDO of boundary scan cell 280 is also “daisy-chained” to the input signal TDI of boundary scan cell 260.

Boundary scan cell 260 includes an input multiplexor 262, a shift/capture register 284, an update register 266, and an output multiplexor 268. Signals TDI and signal DI (that is coupled to the I/O Control signal of core logic 230) are coupled to data inputs of input multiplexor 262. Input multiplexor 262 is arranged to select between signals TDI and DI in response to signal ShiftDR (shift data register). The output of input multiplexor 262 is coupled to the input of shift/capture register 264, where signal ClockDR (clock data register) is arranged to latch (as an output) the output of input multiplexor 262. The output of shift/capture register 264 is coupled to the input of update register 266, where signal UpdateDR (update data register) is arranged to latch (as an output) the output of update register 266. Output multiplexor 268 is arranged to output as DO (data output) TDI and DI in response to signal UpdateDR (shift data register). Signal TDO of boundary scan cell 260 is also “daisy-chained” to the input signal TDI of boundary scan cell 240.

Boundary scan cell 240 includes an input multiplexor 242, a shift/capture register 284, an update register 246, and an output multiplexor 248. Signals TDI and signal DI (that is coupled to the output signal Y of I/O pad cell 220) are coupled to data inputs of input multiplexor 242. Input multiplexor 242 is arranged to select between signals TDI and DI in response to signal ShiftDR (shift data register). The output of input multiplexor 242 is coupled to the input of shift/capture register 244, where signal ClockDR (clock data register) is arranged to latch (as an output) the output of input multiplexor 242. The output of shift/capture register 244 is coupled to the input of update register 246, where signal UpdateDR (update data register) is arranged to latch (as an output) the output of update register 246. Output multiplexor 248 is arranged to output as DO (data output) TDI and DI in response to signal UpdateDR (shift data register). Signal TDO of boundary scan cell 240 is also “daisy-chained” to the input signal TDI of a downstream boundary scan cell (such as a boundary scan cell 280 that is associated with another boundary scan test node.

Table 1 describes three types of operation of boundary scan test node 200 in an internal (INTEST) mode:

TABLE 1

| Signal Name | Shift Operation | Update Operation | Capture Operation |
|---|---|---|---|
| ShiftDR | 1 | 0 | 0 |
| ClockDR | Clock | 0 | Clock |
| UpdateDR | 1 | Clock | 0 |
| Mode | 1 | 1 | 1 |

When the mode is in an INTEST state, signal Mode remains high, which places (and maintains) the boundary scan cells 240, 260, and 280 in the internal test mode. During the internal test mode, the boundary scan cells are coupled between the TDI and the TDO signals. The internal test mode includes the shift operation (e.g., to shift data along the scan chain), the update operation (e.g., to read captured data out of the scan chain), and the capture operation (e.g., to capture data present on the output data pin of the core logic 230).

During the shift operation, signal ShiftDR is high, which selects the TDI inputs of the respective input multiplexers of boundary scan cells 240, 260, and 280. When signal ClockDR transitions (e.g., is clocked from low to high), the output (TDO) of each boundary scan cell is passed along a serial scan chain to the input (TDI) of a next-connected boundary scan cell. The serial scan chain is formed, for example, by daisy-chaining the TDO output of each boundary scan cell to the TDI input of the next-connected boundary scan cell.

During the update operation, the output of each shift/capture register is latched by the respective update register of a boundary scan cell. When signal UpdateDR has an active transition (e.g., is clocked from low to high), the output of each shift/capture register is latched by the respective update register and output by the respective output multiplexor. For example, output multiplexor 288 couples the output of the update register 286 to the A data input of I/O pad cell 220, while output multiplexor 268 couples the output of the update register 266 to the GZ control input of I/O pad cell 220. The GZ control path input enables a feed-through path via the Y output of I/O pad cell 220 to the DI input of boundary scan cell 240. The output multiplexor 248 of boundary scan cell 240 couples the output of the update register 246 to the data input of core logic 230 (thus applying a test stimulus input to the core logic 230). After an internal test is performed, a test result output of the core logic is captured by performing a capture operation.

During the capture operation, signal ShiftDR is low, which selects the DI input of each input multiplexer (282, 262, and 242) and couples each input to a respective shift/capture register (284, 264, and 244). For example, the DI input of input multiplexer 282 is coupled to the output data signal of core logic 230, the DI input of input multiplexer 262 is coupled to the I/O control data signal, while the DI input of input multiplexor 242 is coupled to the Y output of I/O pad cell 220. When signal ClockDR transitions, each of the inputs is latched (captured) by a respective shift/capture register. Accordingly, sequences of shift, update capture, and update operations are used to provide a single data input to a node during a single internal test of a convention boundary scan system.

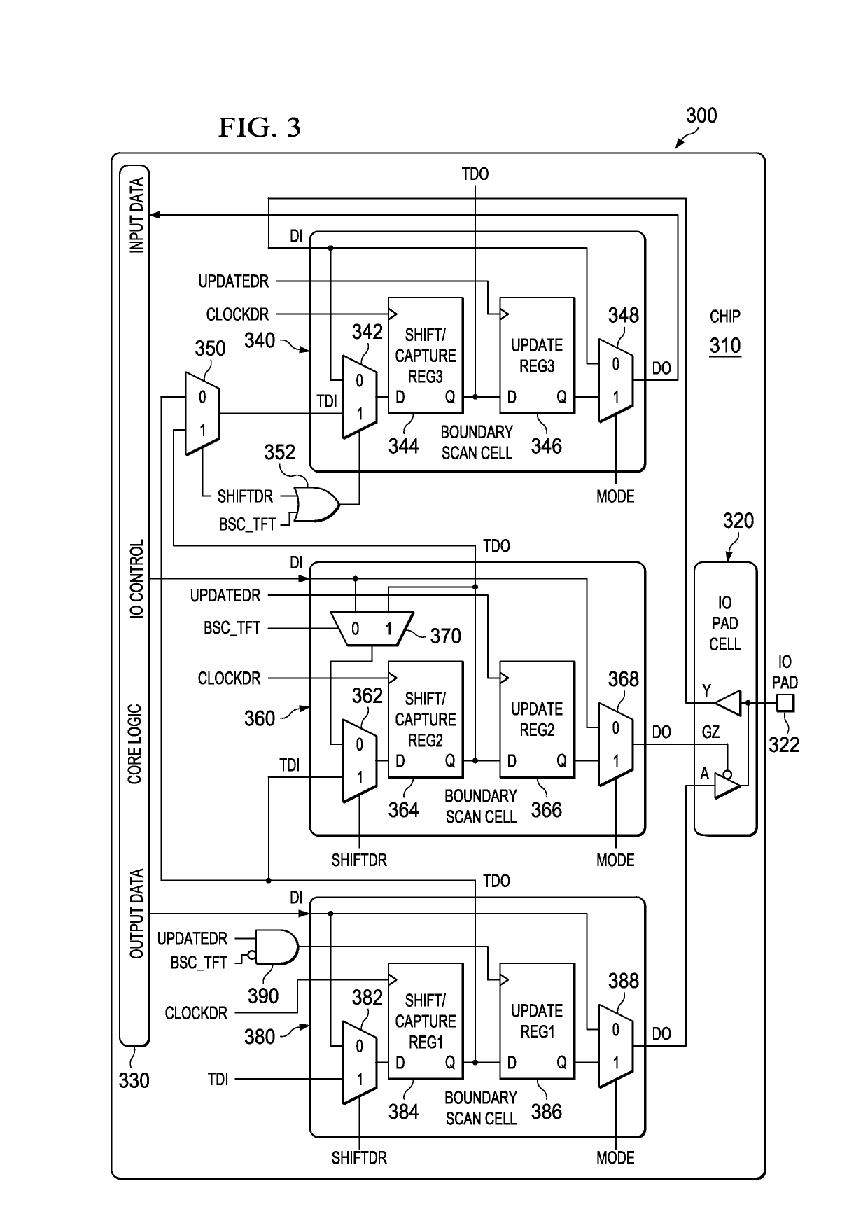

FIG. 3 is a schematic diagram illustrating a multiple input data boundary scan test node in accordance with embodiments of the disclosure. Boundary scan test node 300 includes chip (substrate) 310, I/O pad cell 320, core logic 330, and boundary scan cells 340, 360, and 380. Boundary scan test node 300 is formed on chip 310. As described below, boundary scan test node 300 includes a selectable series connection that is arranged between an output shift/capture register (e.g., shift capture register 384) and an input shift/capture register (e.g., shift capture register 344) in scan flip-flops of a scan chain. The series connection is selected by asserting signal BSC_TFT (boundary scan cell transition fault test).

I/O pad cell 320 is similar to I/O pad cell 220 and is provided to input data to or output data from core logic 330 as well as to provide test stimulus (signal Y) and receive test results (signal A) of the boundary scan test node 300 in an external test (EXTEST) mode. Signal GZ (output enable) controls whether signal A is to be driven as an output or whether an input signal present at the I/O pad 322 is read as an input.

Core logic 330 provides an input data signal, a control output signal, and an output data signal for testing using the boundary scan cells 340, 360, and 380. Boundary scan cell 340 is arranged to select and latch the data input signal of core logic 330. Boundary scan cell 360 is arranged to select and latch the I/O control output signal of core logic 330. Boundary scan cell 380 is arranged to select and latch the data output signal of core logic 330.

Boundary scan cell 380 includes an input multiplexor 382, a shift/capture register 384, an update register 386, and an output multiplexor 388. Signals TDI (“test data in” of the scan chain) and signal DI (“data in” that is coupled to the output data signal of core logic 330) are coupled to data inputs of input multiplexor 382. Input multiplexor 382 is arranged to select between signals TDI and DI in response to signal ShiftDR (shift data register). The output of input multiplexor 382 is coupled to the input of shift/capture register 384, where signal ClockDR (clock data register) is arranged to latch (as an output) the output of input multiplexor 382. The output of shift/capture register 384 is coupled to the input of update register 386, where signal UpdateDR (update data register) is arranged to latch (as an output) the output of update register 386 when signal BST_TFT is not asserted (see gate 390). Output multiplexor 388 is arranged to output as DO (data output) TDI and DI in response to signal UpdateDR (shift data register). Signal TDO of boundary scan cell 380 is also daisy-chained to the input signal TDI of boundary scan cell 360.

Boundary scan cell 360 includes an input multiplexor 362, a shift/capture register 364, an update register 366, an output multiplexor 368, and a multiplexor 370. Multiplexor 370 is arranged to couple the output of the shift/capture register 364 to the “low” (e.g., selected when the multiplexor control signal is low) input of the input multiplexor 362 when signal BST_TFT is asserted. When signal BST_TFT is not asserted, multiplexor 370 is arranged to couple the I/O control signal to the low input of the input multiplexor 362. Signal TDI (which is coupled to the output of the shift capture register 384) is coupled to the high input of input multiplexor 362. Input multiplexor 362 is arranged to select between signal TDI and the output of multiplexor 370 in response to signal ShiftDR (shift data register). The output of input multiplexor 362 is coupled to the input of shift/capture register 364, where signal ClockDR (clock data register) is arranged to latch (as an output) the output of input multiplexor 362. The output of shift/capture register 364 is coupled to the input of update register 366, where signal UpdateDR (update data register) is arranged to latch (as an output) the output of update register 366. Output multiplexor 368 is arranged to output as DO (data output) TDI and DI in response to signal UpdateDR (shift data register). Signal TDO of boundary scan cell 360 is also daisy-chained to the input signal TDI of boundary scan cell 340.

Boundary scan cell 340 includes an input multiplexor 342, a shift/capture register 344, an update register 346, and an output multiplexor 348. Series connection multiplexor 350 couples the output of Shift/Capture register 384 to Signal TDI when signal ShiftDR is low and couples the output of Shift/Capture register 364 to Signal TDI when signal ShiftDR is high. Signal TDI and signal DI (from output signal Y of I/O pad cell 320) are coupled to data inputs of input multiplexor 342. Input multiplexor 342 is arranged to select between signals TDI and DI when either signal ShiftDR (shift data register) or signal BSC_TFT are asserted. The output of input multiplexor 342 is coupled to the input of shift/capture register 344, where signal ClockDR (clock data register) is arranged to latch (as an output) the output of input multiplexor 342. The output of shift/capture register 344 is coupled to the input of update register 346, where signal UpdateDR (update data register) is arranged to latch (as an output) the output of update register 346. Output multiplexor 348 is arranged to output as DO (data output) TDI and DI in response to signal UpdateDR (shift data register). Signal TDO of boundary scan cell 340 is also daisy-chained to the input signal TDI of a downstream boundary scan cell (such as a boundary scan cell 380 that is associated with another boundary scan test node.

Table 2 describes three types of operation of boundary scan test node 300 in an internal (INTEST) mode:

TABLE 2

| Signal Name | Shift Operation | Update Operation | Capture Operation |
|---|---|---|---|
| ShiftDR | 1 | 0 | 0 |
| ClockDR | Clock | 0 | 2Clock |
| UpdateDR | 0 | 0 | 2Clock |
| Mode | 1 | 1 | 1 |
| BSC_TFT | 1 | 1 | 1 |

When a transition fault test is performed on boundary scan test node 300, signals Mode and signal BSC_TFT remain high, which places (and maintains) the boundary scan cells 340, 360, and 380 in the internal test mode. During the internal test mode, the boundary scan cells are coupled between the TDI and the TDO signals. The internal test mode includes the shift operation (e.g., to shift data along the scan chain), the update operation (e.g., to read captured data out of the scan chain), and the capture operation (e.g., to capture data present on the output data pin of the core log 330). As noted in Table 2, elements of the capture operation and the update operation can be accomplished at the same time.

During the shift operation, signal ShiftDR is high, which selects the TDI inputs of the respective input multiplexers of boundary scan cells 340, 360, and 380. When signal ClockDR transitions (e.g., is clocked from low to high), the output (TDO) of each boundary scan cell is passed along a serial scan chain to the input (TDI) of a next-connected boundary scan cell.

During the capture and update operations (where both the capture and the update operations are combined), signal ShiftDR is low. In boundary scan cell 380, the DI input of input multiplexer 382 is selected (when signal ShiftDR is low) and coupled to the input of shift/capture register 384. In boundary scan cell 360, the DI input of input multiplexer 342 is selected (when signal ShiftDR is low and signal BSC_TFT is also low) and coupled to the input of shift/capture register 364, whereas the output of shift/capture register 386 is “wrapped around” and coupled to the input of shift/capture register 364 when signal BSC_TFT is active. In boundary scan cell 340, the DI input of input multiplexer 342 is selected (when signal ShiftDR is low and signal BSC_TFT is also low) and coupled to the input of shift/capture register 346, whereas the output of shift/capture register 384 is selected and coupled to the input of shift/capture register 344 when signal BSC_TFT is active.

After the signal ShiftDR is set low and signals Mode and BSC_TFT are set high, clock signals ClockDR and UpdateDR each transition twice during the capture operation. Each of the selected inputs is latched (e.g., captured) by a respective shift/capture register and passed (e.g., updated) through the respective update register during the first and second transitions of the ClockDR and UpdateDr and the clocks.

As an example of how multiple data bit is input from a single input (and captured from a single output) of the core logic 330, two input bits of data (for test stimulus) are shifted into the boundary scan node 300 during a first shift operation. A first input data bit is shifted into shift/capture register 384 during a first ShiftDR active transition, while during a second ShiftDR active transition, the first input data bit is shifted into shift/capture register 344 and a second input data bit is shifted into shift/capture register 384.

Next, an at-speed test is initiated while providing two active transitions of the UpdateDR clock (and the ClockDR clock) where the first input data bit is applied to an input of the core logic 330 after the first active transition, and the second input data bit is applied to the input of the core logic 330 after the second active transition. Thus two data bits are applied to the data input of the core logic 330 during a single at-speed test.

Results of the single at-speed test are likewise captured by the two active transitions of the UpdateDR clock and the ClockDR clock where the first output data bit is captured from the core logic 330 by (output) shift/capture register 384 after the first active transition, and the first data bit is transferred to the (input) shift/capture register 344 while the second data bit is captured from the core logic 330 by (output) shift/capture register 384 after the second active transition. Thus two data bits are captured from the data output of the core logic 330 during a single at-speed test.

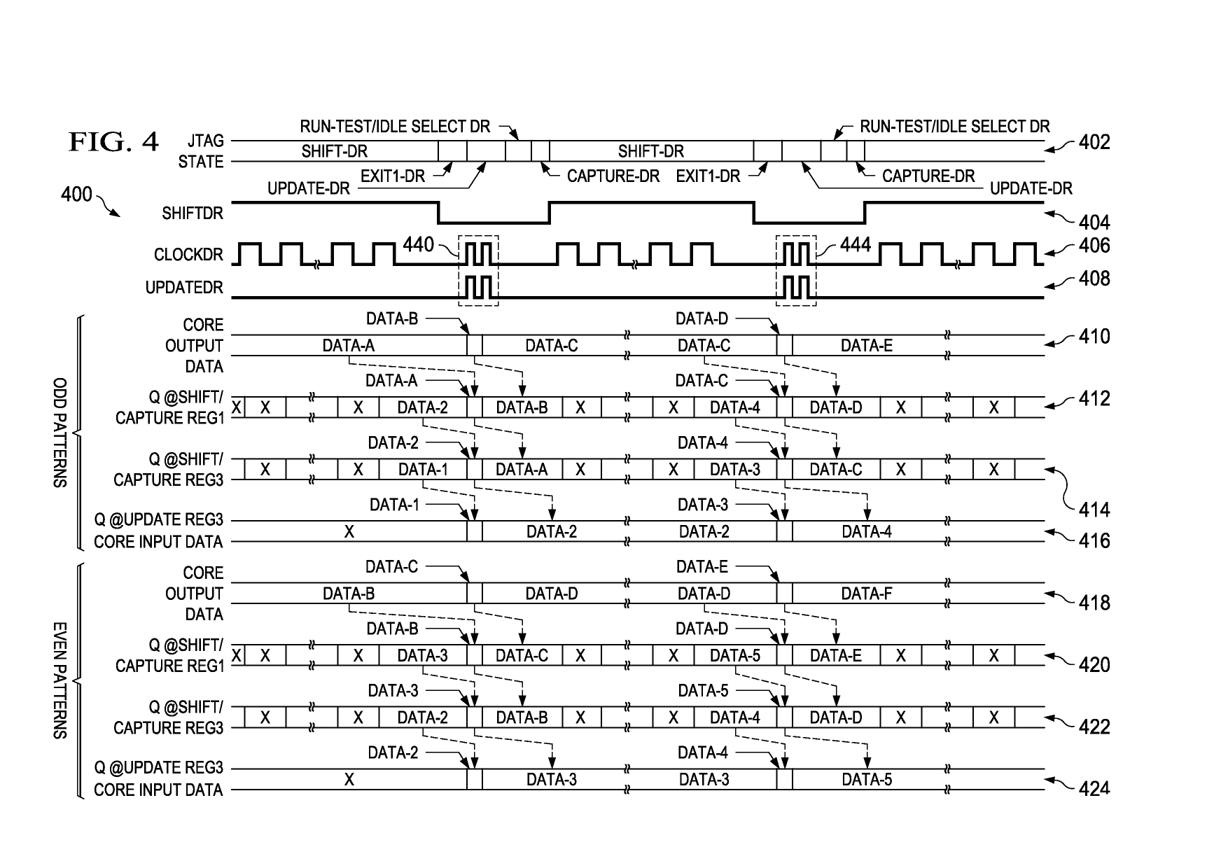

Thus two data bits are input to the data input of core logic 330 (clocked through output multiplexor 348) and two data bits are captured from the data output of core logic 330 (clocked through input multiplexor 382) during a single capture operation using the series connection selected by multiplexor 350. The propagation of data through the boundary scan latches is further described with reference to FIG. 4.

FIG. 4 is a timing diagram illustrating operation of a multiple input data boundary scan test node in accordance with embodiments of the disclosure. Timing diagram 400 includes traces of signals that illustrate changes in the signals over time (which is shown as progressing from left to right). More specifically, trace 402 represents the JTAG state of a multiple input data boundary scan test node during shift, update, and capture operations. Traces 404, 406, and 408 represent the state of the clock signals ShiftDR, ClockDR, and UpdateDR respectively.

Traces 410, 412, 414, and 416 represent signals associated with odd data patterns applied to and received from a first multiple input data boundary scan test node. Trace 410 represents the core output data (such as from a first output data pin associated with the first multiple input data boundary scan test node). Trace 412 represents the output of a first shift/capture register (e.g., a shift/capture register 1) having an input, for example, that is coupled to the data output of the associated core logic. Trace 414 represents the output of a second shift/capture register (e.g., a shift/capture register 3) having an input, for example, that is coupled to the output of the first shift/capture register. Trace 416 represents the output of an update register (e.g., update register 3) having an input, for example, that is coupled to the output of the second shift/capture register, wherein the output of the update register is used to supply core input data (and is coupled to a first input data pin that is associated with the first multiple input data boundary scan test node).

Traces 418, 420, 422, and 424 represent signals associated with even data patterns applied to and received from a second multiple input data boundary scan test node that is downstream (in the scan chain) from the first multiple input data boundary scan test node. Trace 418 represents the core output data (such as from a first output data pin associated with the second multiple input data boundary scan test node). Trace 420 represents the output of a first shift/capture register (e.g., a shift/capture register 1 of the second multiple input data boundary scan test node) having an input, for example, that is coupled to the data output of the associated core logic. Trace 422 represents the output of a second shift/capture register (e.g., a shift/capture register 3 of the second multiple input data boundary scan test node) having an input, for example, that is coupled to the output of the first shift/capture register. Trace 424 represents the output of an update register (e.g., update register 3 of the second multiple input data boundary scan test node) having an input, for example, that is coupled to the output of the second shift/capture register, wherein the output of the update register is used to supply core input data (and is coupled to a first input data pin that is associated with the second multiple input data boundary scan test node.)

In operation, the shift/capture registers are initialized during the Shift operation by asserting signal ShiftDR (trace 404) and clocking the clock signal ClockDR (trace 406). When the shift/capture registers are initialized, the signal ShiftDR is deasserted and the JTAG state (trace 402) enters the “Exit1-DR” (exit the shift operation of the data registers) state.

The state of signals associated with odd patterns during the Exit-1DR state is now described. The core logic outputs the value “Data-A” at an associated data output as indicated in trace 410. Likewise, the output of the shift/capture register 1 of the first (odd patterns) multiple input data boundary scan test node is arranged to output “Data-2” (for eventual test stimulus) as indicated by trace 412. Further, the output of the shift/capture register 3 of the first (odd patterns) multiple input data boundary scan test node is arranged to output “Data-1” as indicated by trace 414. Also during this state, the output of the associated core logic data input (trace 416) is undefined.

The state of signals associated with even patterns during the Exit-1DR state is now described. The core logic outputs the value “Data-B at an associated data output as indicated in trace 418. Likewise, the output of the shift/capture register 1 of the second (even patterns) multiple input data boundary scan test node is arranged to output “Data-3” (for eventual test stimulus) as indicated by trace 420. Further, the output of the shift/capture register 3 of the second (even patterns) multiple input data boundary scan test node is arranged to output “Data-2” as indicated by trace 422. Also during this state, the output of the associated core logic data input (trace 424) is undefined.

When the JTAG state (trace 402) transitions from the Exit1-DR state to the Update-DR state, both clock signals ClockDR (trace 406) and UpdateDR (trace 408) are doubly clocked at double clock period 440. During double clock period 440, a first internal test of the core logic is initiated, which is executed at an internal clock speed that is normally faster than the clock rate used to generate the double-clocks during a double clock period (e.g., double clock period 440).

At the first active transition of the clocks (ClockDR and UpdateDR) during double clock period 440, the (core-logic-internally generated) core output data for odd patterns (trace 410) changes to “Data B.” Likewise, the shift/capture register 1 of the first (odd patterns) multiple input data boundary scan test node is arranged to latch the “Data-A” value (formerly output as the core output data) as indicated by trace 412. Further, the shift/capture register 3 of the first (odd patterns) multiple input data boundary scan test node is arranged to latch the value “Data-2” (formerly output from the associated shift/capture register 1) as indicated by trace 414. Also the update register 3 of the first (odd patterns) multiple input data boundary scan test node is arranged to latch the value “Data-1” (formerly output from the associated shift/capture register 3) as indicated by trace 416.

At the first active transition of the clocks (ClockDR and UpdateDR) during double clock period 440, the (core-logic-internally generated) core output data for even patterns (trace 418) changes to “Data C.” Likewise, the shift/capture register 1 of the second (even patterns) multiple input data boundary scan test node is arranged to latch the “Data-B” value (formerly output as the core output data) as indicated by trace 420. Further, the shift/capture register 3 of the second (even patterns) multiple input data boundary scan test node is arranged to latch the value “Data-3” (formerly output from the associated shift/capture register 1) as indicated by trace 422. Also the update register 3 of the second (even patterns) multiple input data boundary scan test node is arranged to latch the value “Data-2” (formerly output from the associated shift/capture register 3) as indicated by trace 424.

At the second active transition of the clocks (ClockDR and UpdateDR) during double clock period 440, the (core-logic-internally generated) core output data for odd patterns (trace 410) changes to “Data C.” Likewise, the shift/capture register 1 of the first (odd patterns) multiple input data boundary scan test node is arranged to latch the “Data-B” value (formerly output as the core output data) as indicated by trace 412. Further, the shift/capture register 3 of the first (odd patterns) multiple input data boundary scan test node is arranged to latch the value “Data-A” (formerly output from the associated shift/capture register 1) as indicated by trace 414. Also the update register 3 of the first (odd patterns) multiple input data boundary scan test node is arranged to latch the value “Data-2” (formerly output from the associated shift/capture register 3) as indicated by trace 416.

At the first active transition of the clocks (ClockDR and UpdateDR) during double clock period 440, the (core-logic-internally generated) core output data for even patterns (trace 418) changes to “Data D.” Likewise, the shift/capture register 1 of the second (even patterns) multiple input data boundary scan test node is arranged to latch the “Data-C” value (formerly output as the core output data) as indicated by trace 420. Further, the shift/capture register 3 of the second (even patterns) multiple input data boundary scan test node is arranged to latch the value “Data-B” (formerly output from the associated shift/capture register 1) as indicated by trace 422. Also the update register 3 of the second (even patterns) multiple input data boundary scan test node is arranged to latch the value “Data-3” (formerly output from the associated shift/capture register 3) as indicated by trace 424.

Accordingly, test data stimuli Data-1 and Data-2 is applied during the at-speed test, and test data results Data-B and Data-C are captured during the at-speed test (e.g., during the UpdateDR operation) for odd patterns. For even patterns, test data stimuli Data-2 and Data-3 is applied during the at-speed test, and test data results Data-C and Data-D are captured during the at-speed test (e.g., during the UpdateDR operation).

After the double clock period 440, the JTAG state changes to the “Run-test/Idle Select DR” state as indicated in trace 402. During this state the shift/capture registers and the update registers maintain the data as described above. When the JTAG state changes from the “Run-test/Idle Select DR” state to the “Capture-DR” state as indicated in trace 402, clock signal ShiftDR is toggled high and clock signal ClockDR is repeatedly clocked to read data from (e.g., test data results) the scan chain as well as to clock data into (e.g., test data stimulus) the scan chain for evaluation of the first test results and to set up data for a second at-speed test (for example).

To set up the data stimulus for the second test, the shift/capture registers are initialized during the Shift operation by asserting signal ShiftDR (trace 404) and clocking the clock signal ClockDR (trace 406). When the shift/capture registers are initialized, the signal ShiftDR is toggled low and the JTAG state (trace 402) enters the “Exit1-DR” (exit the shift operation of the data registers) state.

The state of signals associated with odd patterns during the Exit-1DR state is now described. The core logic outputs the value “Data-C” at an associated data output as indicated in trace 410. Likewise, the output of the shift/capture register 1 of the first (odd patterns) multiple input data boundary scan test node is arranged to output “Data-4” (for eventual test stimulus) as indicated by trace 412. Further, the output of the shift/capture register 3 of the first (odd patterns) multiple input data boundary scan test node is arranged to output “Data-3” as indicated by trace 414. Also during this state, the output of the associated core logic data input (trace 416) reflects the value “Data-2.”

The state of signals associated with even patterns during the Exit-1DR state is now described. The core logic outputs the value “Data-D at an associated data output as indicated in trace 418. Likewise, the output of the shift/capture register 1 of the second (even patterns) multiple input data boundary scan test node is arranged to output “Data-5” (for eventual test stimulus) as indicated by trace 420. Further, the output of the shift/capture register 3 of the second (even patterns) multiple input data boundary scan test node is arranged to output “Data-4” as indicated by trace 422. Also during this state, the output of the associated core logic data input (trace 424) reflects the value “Data-3.”

When the JTAG state (trace 402) transitions from the Exit1-DR state to the Update-DR state, both clock signals ClockDR (trace 406) and UpdateDR (trace 408) are doubly clocked at double clock period 444. During double clock period 444, a second internal test of the core logic is initiated, which is executed at an internal clock speed that is normally faster than the clock rate used to generate the double-clocks during a double clock period (e.g., double clock period 444).

At the first active transition of the clocks (ClockDR and UpdateDR) during double clock period 444, the (core-logic-internally generated) core output data for odd patterns (trace 410) changes to “Data D.” Likewise, the shift/capture register 1 of the first (odd patterns) multiple input data boundary scan test node is arranged to latch the “Data-C” value (formerly output as the core output data) as indicated by trace 412. Further, the shift/capture register 3 of the first (odd patterns) multiple input data boundary scan test node is arranged to latch the value “Data-4” (formerly output from the associated shift/capture register 1) as indicated by trace 414. Also the update register 3 of the first (odd patterns) multiple input data boundary scan test node is arranged to latch the value “Data-3” (formerly output from the associated shift/capture register 3) as indicated by trace 416.

At the first active transition of the clocks (ClockDR and UpdateDR) during double clock period 444, the (core-logic-internally generated) core output data for even patterns (trace 418) changes to “Data E.” Likewise, the shift/capture register 1 of the second (even patterns) multiple input data boundary scan test node is arranged to latch the “Data-D” value (formerly output as the core output data) as indicated by trace 420. Further, the shift/capture register 3 of the second (even patterns) multiple input data boundary scan test node is arranged to latch the value “Data-5” (formerly output from the associated shift/capture register 1) as indicated by trace 422. Also the update register 3 of the second (even patterns) multiple input data boundary scan test node is arranged to latch the value “Data-4” (formerly output from the associated shift/capture register 3) as indicated by trace 424.

At the second active transition of the clocks (ClockDR and UpdateDR) during double clock period 444, the (core-logic-internally generated) core output data for odd patterns (trace 410) changes to “Data E.” Likewise, the shift/capture register 1 of the first (odd patterns) multiple input data boundary scan test node is arranged to latch the “Data-D” value (formerly output as the core output data) as indicated by trace 412. Further, the shift/capture register 3 of the first (odd patterns) multiple input data boundary scan test node is arranged to latch the value “Data-C” (formerly output from the associated shift/capture register 1) as indicated by trace 414. Also the update register 3 of the first (odd patterns) multiple input data boundary scan test node is arranged to latch the value “Data-4” (formerly output from the associated shift/capture register 3) as indicated by trace 416.

At the first active transition of the clocks (ClockDR and UpdateDR) during double clock period 444, the (core-logic-internally generated) core output data for even patterns (trace 418) changes to “Data F.” Likewise, the shift/capture register 1 of the second (even patterns) multiple input data boundary scan test node is arranged to latch the “Data-E” value (formerly output as the core output data) as indicated by trace 420. Further, the shift/capture register 3 of the second (even patterns) multiple input data boundary scan test node is arranged to latch the value “Data-D” (formerly output from the associated shift/capture register 1) as indicated by trace 422. Also the update register 3 of the second (even patterns) multiple input data boundary scan test node is arranged to latch the value “Data-5” (formerly output from the associated shift/capture register 3) as indicated by trace 424.

Accordingly, test data stimuli Data-3 and Data-4 is applied during the at-speed test, and test data results Data-D and Data-E are captured during the at-speed test (e.g., during the UpdateDR operation) for the odd patterns. For the even patterns, test data stimuli Data-4 and Data-5 is applied during the at-speed test, and test data results Data-E and Data-F are captured during the at-speed test (e.g., during the UpdateDR operation).

After the double clock period 440, the JTAG state changes to the “Run-test/Idle Select DR” state as indicated in trace 402. During this state the shift/capture registers and the update registers maintain the data as described above. When the JTAG state changes from the “Run-test/Idle Select DR” state to the “Capture-DR” state as indicated in trace 402, clock signal ShiftDR is toggled high and clock signal ClockDR is repeatedly clocked to read data from (e.g., test data results) the scan chain as well as to clock data into (e.g., test data stimulus) the scan chain for evaluation of the first test results and to set up data for a second at-speed test (for example).

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A boundary scan node for scan chain testing of a core logic, comprising:
a first boundary scan cell having an input that is coupled to a first data output of the core logic;
a second boundary scan cell having an output that is coupled to a first data input of the core logic; and
a multiplexor that is arranged to couple a programmable series connection from an output of the first boundary scan cell to an input of the second boundary scan cell when the boundary scan node is arranged in an internal test mode for the core logic.

2. The boundary scan node of claim 1, wherein the first boundary scan cell is arranged to transfer latched first stimulus data from the first boundary scan cell to the second boundary scan cell using the programmable series connection during a first active transition of a data register clock that is asserted during a first internal test of the core logic.

3. The boundary scan node of claim 2, wherein the second boundary scan cell is arranged to transfer latched second stimulus data from the second boundary scan cell to the first data input of the core logic during the first active transition of the data register clock that is asserted during the first internal test of the core logic.

4. The boundary scan node of claim 3, wherein the second boundary scan cell is arranged to transfer the latched first stimulus data to the first data input of the core logic during a second active transition of the data register clock that is asserted during the first internal test of the core logic.

5. The boundary scan node of claim 1, wherein the first boundary scan cell is arranged to transfer latched first response data from the first boundary scan cell to the second boundary scan cell using the programmable series connection in response to a data register clock that is actively transitioned during a first internal test of the core logic.

6. The boundary scan node of claim 1, wherein the first boundary scan cell is arranged to transfer latched first stimulus data from the first boundary scan cell to the second boundary scan cell using the programmable series connection in response to a first active transition of a data register clock during a first internal test of the core logic, wherein the first boundary scan cell is arranged to transfer latched first response data from the first boundary scan cell to the second boundary scan cell using the programmable series connection in response to a second active transition of the data register clock during the first internal test of the core logic.

7. The boundary scan node of claim 1, wherein the latched first stimulus data is latched using scan chain before initiation of the first internal test of the logic core, wherein the internal test of the logic core is executed at a clock speed that is higher than the clock speed of the data register clock, and wherein the latched first response data is latched in response to data received from the first data output of the core logic.

8. The boundary scan node of claim 1, wherein the first boundary scan cell is arranged to latch first response data in response to data received from the data output of the core logic during a first active transition of a data register clock that is asserted during a first internal test of the core logic.

9. The boundary scan node of claim 8, wherein the second boundary scan cell is arranged to transfer first stimulus data to the data input of the core logic during the first active transition of the data register clock that is asserted during the first internal test of the core logic, and wherein the first boundary scan cell is arranged to transfer the latched first response data to the second boundary scan cell during a second active transition of the data register clock that is asserted during the first internal test of the core logic.

10. The boundary scan node of claim 9, wherein the first boundary scan cell is arranged to transfer latched second stimulus data to the second boundary scan cell during the first active transition of the data register clock that is asserted during the first internal test of the core logic, and wherein the second boundary scan cell is arranged to transfer the latched second stimulus data to the data input of the core logic during the second active transition of the data register clock that is asserted during the first internal test of the core logic.

11. The boundary scan node of claim 10, wherein the first boundary scan cell is arranged to latch second response data in response to data received from the data output of the core logic during the first active transition of the data register clock that is asserted during the first internal test of the core logic.

12. The boundary scan node of claim 1, wherein the input of the first boundary scan cell is coupled to an input of a shift/capture register of the first boundary scan cell, wherein the output of the shift/capture register of the first boundary scan cell is coupled to the programmable series connection, wherein the input of the second boundary scan cell is coupled to an input of a shift/capture register cell of the second boundary scan cell, wherein an output of the shift/capture register of the second boundary scan cell is coupled to an input of an update register of the second boundary scan cell, and wherein the output of the update register is coupled to the output of the second boundary scan cell.

13. The boundary scan node of claim 1, wherein the shift/capture register of the first boundary scan cell, the shift/capture register of the second boundary scan cell, and the update register of the second boundary scan cell are clocked by a data register clock during a scan chain shift operation, to read response data from an internal test of the core logic.

14. An electronic system having a self-test capability, comprising:
core logic that is arranged to perform an internal test in response to stimulus data; and
a boundary scan chain node having a first boundary scan cell having an input that is coupled to a first data output of the core logic, a second boundary scan cell having an output that is coupled to a first data input of the core logic; and a programmable series connection from an output of the first boundary scan cell to an input of the second boundary scan cell when the boundary scan node is arranged in an internal test mode for the core logic.

15. The system of claim 14, wherein the first boundary scan cell is arranged to transfer latched first stimulus data from the first boundary scan cell to the second boundary scan cell using the programmable series connection during a first active transition of a data register clock that is asserted during a first internal test of the core logic, and wherein the second boundary scan cell is arranged to transfer the latched first stimulus data to the first data input of the core logic during a second active transition of the data register clock that is asserted during the first internal test of the core logic.

16. The system of claim 15, wherein the first boundary scan cell is arranged to latch first response data in response to data received from the data output of the core logic during the first active transition of the data register clock that is asserted during the first internal test of the core logic, and wherein in the first boundary scan cell is arranged to transfer the latched first response data to the second boundary scan cell during the second active transition of the data register clock that is asserted during the first internal test of the core logic.

17. A method of conveying multiple data in a boundary scan node testing of core logic, comprising:
coupling an input of a first boundary scan cell to a first data output of the core logic;
coupling an output of a second boundary scan cell to a first data input of the core logic; and
selectively coupling a programmable series connection from an output of the first boundary scan cell to an input of the second boundary scan cell when the boundary scan node is arranged in an internal test mode for the core logic.

18. The method of claim 17, comprising latching first response data in response to data received from the data output of the core logic during a first active transition of a data register clock that is asserted during a first internal test of the core logic, and transferring the latched first response data to the second boundary scan cell during a second active transition of the data register clock that is asserted during the first internal test of the core logic.

19. The method of claim 18, comprising transferring latched first stimulus data from the first boundary scan cell to the second boundary scan cell using the programmable series connection during the first active transition of a data register clock that is asserted during the first internal test of the core logic, and transferring the latched first stimulus data to the first data input of the core logic during the second active transition of the data register clock that is asserted during the first internal test of the core logic.

20. The method of claim 18, comprising using the data register clock to clock a shift/capture data register and an update register of the first boundary scan register and to clock a shift/capture data register and an update register of the second boundary scan register during a scan chain shift operation, to write stimulus data provided for testing the core logic into the first and second boundary scan registers and to read response data resulting from testing the core logic from the first and second boundary scan registers.
